(19) United States
(12) Patent Application Publication
(10) Pub. No.: US 2010/0320788 A1
(43) Pub. Date: Dec. 23, 2010

(54) Vessel removal and transport system

(76) Inventor: Roger Blanchard, Pepperell, MA (US)

Correspondence Address: LAMBERT & ASSOCIATES, 92 STATE STREET, BOSTON, MA, 02109-2004, US

(21) Appl. No.: 12/456,399

(22) Filed: Jun. 17, 2009

(51) Int. Cl. B25B 9/00

(52) U.S. Cl. 294/99.2

(57) ABSTRACT

An improved hand-held apparatus, referred to herein as a heating/cooling vessel (bowl) removal and transportation system, for safely lifting and transporting super-cooled or heated bowls from one area to another. The bowl transporter supports the bowl in a stable manner, is easy to engage and disengage, possibly even one-handed, and is inexpensive to manufacture.

### BACKGROUND OF THE INVENTION

1. Field of the Invention

The present invention relates to kitchen or laboratory accessories, and more specifically, the present invention relates to hand held apparatuses for the safe removal and transport of heated or super cooled vessels, particularly bowls, from a heating or cooling medium.

2. Description of the Related Art

With the introduction and widespread usage of microwave ovens, people and laboratories commonly heat individual servings of soup, chemicals and the like in an ordinary heating apparatuses, such as bowls, and then attempt to transport the bowls by hand to a table, serving area or bench for consumption or experimentation. A problem that arises is that ordinary bowls and other laboratory apparatuses, unlike pots or pans, are not equipped with handles, and thus the user is liable to incur burning on his or her fingers in the process of transporting the hot bowl from the microwave oven to the destination area. While pot holders and the like have been used to protect consumers from burns, one-handed operation is difficult if not impossible (especially for the elderly), and these devices tend to slip, possibly leading to spillage of the contents, and scalding of the consumer.

Previous inventions have attempted to utilize long metallic prongs that are used to grab the bowl from a distance and transport the bowl from the microwave down to the counter below. However, these prongs tend to provide little support for heavy bowls because they are grab the bowls from a substantial distance. Further, because these prongs provide little support it is difficult to transport these bowls any further than from the microwave to the kitchen counter. The ensuing problems occur where users generally need to transport and place the bowls at serving or dining area that is located at a substantial distance from the microwave. Therefore, users need something that provides support for the bowl so they can carry it a substantial distance to a serving area in an adjacent room.

In summary, investigation of these disclosed devices illustrates that presently, no single device or combination thereof known in the art meets the requirements of providing an easily manageable heating device removal apparatus while simultaneously offering operator safety.

### SUMMARY OF THE INVENTION

The instant invention, as illustrated herein, is clearly not anticipated, rendered obvious, or even present in any of the prior art mechanisms, either alone or in any combination thereof. The primary object of the present invention is to provide an improved hand-held apparatus, referred to herein as a heating or cooling, vessel or bowl removal and transportation system, for safely lifting and transporting super-cooled or hot bowls from one area to another. The bowl transporter supports the bowl in a stable manner, is easy to engage and disengage (possibly with one hand, depending upon the dexterity of the user) and is inexpensive to manufacture.

An additional object of the instant invention is to provide a system designed for personal usage with a microwave wherein a consumer may remove a hot bowl from the microwave without having to actually make contact with the bowl.

A further object of the present invention is to provide a bowl removal and transportation system to be utilized with bowls having a circular base, and a wall that tapers outward from the base in substantially circular, cylindrical or conical cross-section.

Another object of the present invention is to provide a bowl removal and transportation system defined by two separate pieces or members, composed of low to non-heat/radiation conductive material such as composite and variations thereof, polymer, plastic, rubber, aluminum or coated metal, wherein the members are identically shaped to form a substantially circular or oval retaining area when engagement occurs.

It is an object of the instant invention to provide a heating/cooling vessel (bowl) removal and transport system wherein the user simply grasps the ends of the two rods, distal to the heated bowl, and with minimal to no entry into the heating apparatus chamber, is able to remove the heating vessel or bowl.

It is an additional object of the instant invention to provide a system wherein the union of two separate, distinct, rod-like members creates an area to surround the base of a vessel or bowl and securely supports the bowl with no user contact with the bowl or the heating apparatus, oven or microwave.

It is a further object to introduce a heating vessel removal and transport system wherein the user may disengage the system with minimal manual contortion and without physically contacting with the heated vessel.

There has thus been outlined, rather broadly, the more important features of the heating vessel removal and transport system in order that the detailed description thereof that follows may be better understood, and in order that the present contribution to the art may be better appreciated. There are additional features of the invention that will be described hereinafter and will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 is a plan view of the vessel removal and transport system of the instant invention with the two individual members disengaged;

FIG. 2 is a plan view of the vessel removal and transport system of the instant invention with the two individual members engaged;

FIG. 3 is a side view of one of the individual members of the vessel removal and transport system of the instant invention; and,

FIG. 4 is an isometric perspective view of the invention in use, illustrating the two individual members engaged and surrounding and in position to transport a vessel.

### DETAILED DESCRIPTION OF THE PREFERRED EMBODIMENTS

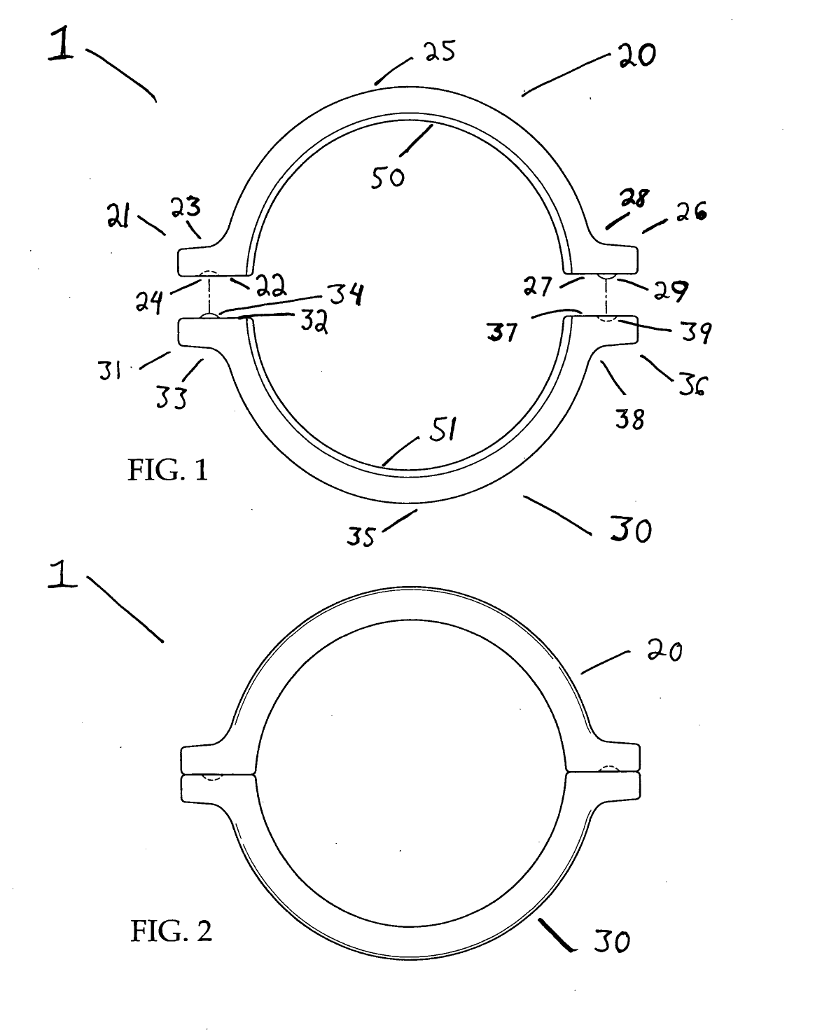

FIG. 1 is a plan view of the vessel removal and transport system 1 of the instant invention with the two individual members disengaged. FIG. 1 further illustrates an object removal and transportation device 1 comprising a first tong-like mechanism 20 comprising a substantially rectangular proximal member 21, said substantially rectangular proximal member comprising an inward planar portion 22 and an outward planar portion 23, said inward planar portion comprising an aperture 24. The first tong-like mechanism 20 further comprises a substantially semi-circular midrange member 25 and a substantially rectangular distal member 26 comprising an inward planar portion 27 and an outward planar portion 28. The inward planar portion 27 comprises a protrusion mechanism 29 extending outwardly from said inward planar member 27.

The object removal and transportation device 1 further comprises a second tong-like mechanism 30 comprising a substantially rectangular proximal member 31, said substantially rectangular proximal member 31 comprising an inward planar portion 32 and an outward planar portion 33, said inward planar portion comprising a protrusion mechanism 34; said protrusion mechanism 34 disposed to mate with said aperture 24 of said first tong-like mechanism 20. The second tong-like mechanism 30 further comprises a substantially semi-circular midrange member 35 and a substantially rectangular distal member 36 comprising an inward planar portion 37 and an outward planar portion 38; said inward planar portion 37 comprising an aperture 39 disposed to mate with said protrusion mechanism 29 of said first tong-like mechanism 20.

Additionally, the engagement of said first tong-like mechanism 20 and said second tong-like mechanism 30 creates a substantially circular object engagement area 40, wherein said first tong-like mechanism and said second tong-like mechanism are disposed to mate and securely support an object, and to securely support an object without user contact of said object.

Moreover, as illustrated in FIG. 1, the substantially semi-circular midrange member 25 of the first tong-like mechanism 20 and the substantially semi-circular midrange member 35 of the second tong-like mechanism 30 may comprise a bevel 50, 51 respectively, of sufficient angle as to afford secure support of the vessel to be retained and transported. Manufactured within the placed within the inner surfaces of the respective semi-circular midrange members, the respective bevels may range between ¼ or ½ inch, whichever provides proper support for differing shapes of vessels.

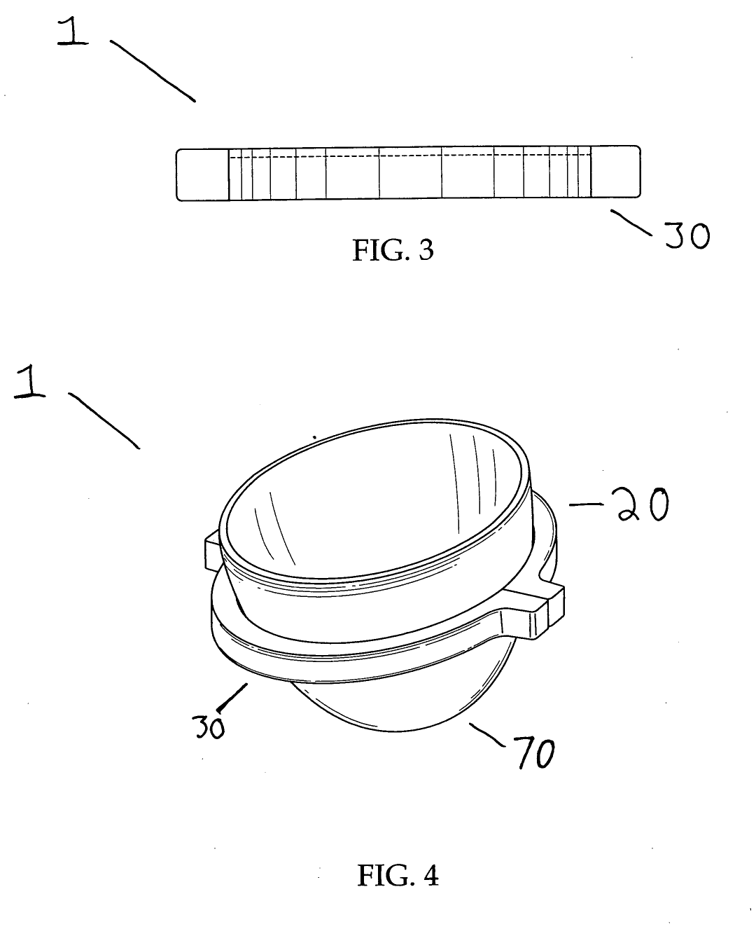

FIG. 2 illustrates a plan view of the vessel removal and transport system of the instant invention with the two individual members engaged in operational mode without a bowl or vessel contained. FIG. 3 is a side view of one of the individual members 20 and 30, of the vessel removal and transport system of the instant invention. FIG. 4 is an isometric perspective view of the invention in use, illustrating the two individual members 20 and 30, engaged and surrounding and in position to transport a vessel 70.

Furthermore, the protrusions and apertures of the first and second tong-like members may be located in numerous positions along the respective inward planar portions, as the sets of opposing protrusions and receiving apertures may be aligned to properly match in order to suppress freedom of movement of one tong with respect to the other tong in the transport phase. In one embodiment, the protrusions and apertures may be substantially centrally disposed upon the respective inward planar portion to ensure maximum surrounding material to protect against wear.

The protrusion mechanisms may be substantially semicircular, substantially conical, substantially cylindrical, substantially triangular, substantially rectangular, or even crafted in any other shape to fit specific needs. And, the corresponding apertures, may, of course be tailored to most properly house the respective shape of protrusion mechanism.

Further, the protrusion mechanisms, if disposed in such a manner, may mate with the corresponding apertures at a 90 degree angle with respect to said inward planar portion, or at differing angles in order to ensure proper secure mating.

In general, the bowl transporter of this invention can be advantageously used with bowls having a circular base, and a wall that tapers outward from the base in a substantially circular cross-section. The bowl transporter is defined by two pieces of plastic that are identically shaped to form an oval when placed together. Each piece of plastic has a straight edge at both ends and curves into a semi circular or U shape in the center where the bowl is placed.

In specific embodiments stating material and dimensions, each tong-like mechanism or retaining mechanism may be made of a polymer such as plastic and at one end, a ¾ of an inch plastic protrusion, nub extension, or projection, that extends outwardly toward an opposing tong-like mechanism or retaining mechanism. On the opposite side of the projection on the tong-like mechanism or retaining mechanism is an aperture or indentation substantially ¾ inch deep.

As stated above, the projections at opposing ends of each tong-like mechanism or retaining mechanism are designed to fit securely in the aperture or indentation of the opposing piece to enable a user to form a substantially circular or oval shape of the retaining area, and properly utilize the above discussed bevel. The retaining area may be designed to fit securely around a wide variety of bowl types and sizes. The straight ends of the transporter are designed to allow a user to grab each end and securely lift and transport the bowl to a serving, dining or processing area.

Thus, the user firstly grasps the ends of the two opposing rods, moves the rods toward the bowl, allowing each semi circular or half oval shaped portion to surround the base of the bowl underneath the underlying support surface. The user secondly engages the distal protrusion with the distal aperture and simply raises the now engaged rods as a unit, such that the curved inner periphery of the arms evenly contact the outer periphery of the bowl. At this point the bowl is supported in a level and stable manner, and the user thirdly may safely transport the bowl to a serving area of the kitchen. When the user has positioned the bowl as desired, the bowl transporter is lowered until the base of the bowl contacts the support surface, wherein after the bowl lifter is lowered to the support surface and removed without disturbing the bowl or its contents.

What is claimed is:

1. An object removal and transportation device comprising:
a first tong-like mechanism comprising:
a substantially rectangular proximal member, said substantially rectangular proximal member comprising an inward planar portion and an outward planar portion, said inward planar portion comprising an aperture;
a substantially semi-circular midrange member; and,
a substantially rectangular distal member comprising an inward planar portion and an outward planar portion; said inward planar portion comprising a protrusion mechanism extending outwardly from said inward planar member;
a second tong-like mechanism comprising:
a substantially rectangular proximal member, said substantially rectangular proximal member comprising an inward planar portion and an outward planar portion, said inward planar portion comprising a protrusion mechanism; said protrusion mechanism disposed to mate with said aperture of said first tong-like mechanism;
a substantially semi-circular midrange member; and,
a substantially rectangular distal member comprising an inward planar portion and an outward planar portion; said inward planar portion comprising an aperture disposed to mate with said protrusion mechanism of said first tong-like mechanism;
wherein engagement of said first tong-like mechanism and said second tong-like mechanism creates a circular object engagement area.

2. The object removal and transportation device of claim 1 wherein said first tong-like mechanism and said second tong-like mechanism are disposed to mate and securedly support an object.

3. The object removal and transportation device of claim 1 wherein said first tong-like mechanism and said second tong-like mechanism are disposed to mate and securedly support an object without user contact of said object.

4. The object removal and transportation device of claim 1 wherein said protrusion of said first tong is centrally disposed upon said inward planar portion.

5. The object removal and transportation device of claim 1 wherein said protrusion of said second tong is centrally disposed upon said inward planar portion.

6. The object removal and transportation device of claim 4 wherein said aperture of said first tong is centrally disposed upon said inward planar portion.

7. The object removal and transportation device of claim 5 wherein said aperture of said second tong is centrally disposed upon said inward planar portion.

8. The object removal and transportation device of claim 1 wherein said protrusion mechanism of said first tong-like member comprises a semi-circular shape.

9. The object removal and transportation device of claim 8 wherein said protrusion mechanism of said second tong-like member comprises a semi-circular shape.

10. The object removal and transportation device of claim 1 wherein said protrusion mechanism of said first tong-like member comprises a semi-spherical shape.

11. The object removal and transportation device of claim 10 wherein said protrusion mechanism of said second tong-like member comprises a semi-spherical shape.

12. The object removal and transportation device of claim 1 wherein said protrusion mechanism of said first tong-like member extends outwardly at a 90 degree angle with respect to said inward planar portion.

13. The object removal and transportation device of claim 13 wherein said protrusion mechanism of said second tong-like member extends outwardly at a 90 degree angle with respect to said inward planar portion.

14. A bowl lifting apparatus comprising:
a set of two plastic members, each member comprising a substantially spherical nub with a diameter of 0.75 inch;
a indentation on each member disposed to be in a position opposite to each of said substantially spherical nubs, each indentation substantially 0.75 inch deep to securely receive substantially spherical nub corresponding to said indentation; and,
wherein each member of said set of two plastic members further comprises a substantially U-shaped portion comprising an internally disposed bevel.

15. The bowl lifting apparatus of claim 14, in wherein said internally disposed bevel is 0.25 inch.

16. The bowl lifting apparatus of claim 14, in wherein said internally disposed bevel is ⅜ inch.

17. The bowl lifting apparatus of claim 14, in wherein said internally disposed bevel is 0.5 inch.

18. A method for removing and transporting a vessel from a microwave chamber comprising:
utilizing a pair of opposing tong-like devices comprising locking mechanisms;
engaging said vessel with said pair of opposing tong-like devices by grasping a proximal end of said opposing tong-like apparatus;
moving said pair of opposing tong-like devices toward said vessel;
enabling a semi circular portion of said pair of opposing tong-like devices to surround the base of the bowl underneath the underlying support surface.
engaging a distal protrusion with a distal aperture of said pair of opposing tong-like devices;
engaging a proximal protrusion with a proximal aperture of said pair of opposing tong-like devices;
sliding said pair of opposing tong-like devices vertically upward as a unit, such that a curved inner periphery of said pair of opposing tong-like devices evenly contact an outer periphery of said vessel;
transporting said pair of opposing tong-like devices with said vessel encased within curved inner periphery of said pair of opposing tong-like devices;
placing said vessel at a resting location;
sliding said pair of opposing tong-like devices vertically downward as a unit, such that said curved inner periphery of said pair of opposing tong-like devices releases contact of said outer periphery of said vessel;
disengaging said proximal protrusion from said proximal aperture of said pair of opposing tong-like devices; and,
disengaging engaging a distal protrusion from said distal aperture of said pair of opposing tong-like devices.
